(19) United States
(12) Patent Application Publication
(10) Pub. No.: US 2013/0124395 A1
(43) Pub. Date: May 16, 2013

(54) Systems And Methods For Disabling Recurring Charges

(71) Applicant: James Siminoff, Pacific Palisades, CA (US)

(72) Inventor: James Siminoff, Pacific Palisades, CA (US)

(21) Appl. No.: 13/293,926

(22) Filed: Nov. 10, 2011

(51) Int. Cl. G06Q 20/38

(52) U.S. Cl. 705/39

(57) ABSTRACT

A system, a method, and a software product disable recurring charges incurred on an account of a user. A plurality of transactions that occurred within a predefined period for the account is received within a server. The transactions are analyzed to identify a recurring charge, which is indicated to the user. A delete button is displayed proximate the recurring charge and the recurring charge is cancelled if the user clicks on the delete button.

### BACKGROUND

Bank accounts, and particularly credit card accounts, are frequently used for recurring charges for services, subscriptions, and the like. Where the number of transactions for an account (bank or credit) is large, it is more difficult and more time consuming for an owner of the account to identify recurring charges within those transactions. Often, the owner will not bother to check transactions for the account, may check transactions infrequently, or may quickly scan the transactions for anomalies, thereby likely failing to notice recurring charges for services and subscriptions that are no longer required.

Marketers are aware of this issue and many companies make their transactions less noticeable to the payer (i.e., the owner of the account) such that the recurring charge on the account remains unnoticed by the owner for as long as possible, even after the service or subscription is no longer used by the owner.

### SUMMARY OF THE INVENTION

In one embodiment, a system disables recurring charges incurred on an account of a user. A transaction analyzer, running on a server, identifies a recurring charge within transactions of the account and an output generator indicates the identified recurring charge to the user.

In another embodiment, a method disables recurring charges incurred on an account of a user. A plurality of transactions that occurred within a predefined period for the account is received within a server. The transactions are analyzed to identify a recurring charge, which is indicated to the user. A delete button is displayed proximate the recurring charge and the recurring charge is cancelled if the user clicks on the delete button.

In another embodiment, a software product has instructions, stored on non-transient computer-readable media, wherein the instructions, when executed by a computer, perform steps for disabling recurring charges incurred on an account of a user. The software product includes instructions for receiving, within a server, a plurality of transactions that occurred within a predefined period for the account, instructions for analyzing the transactions to identify a recurring charge, instructions for indicating the identified recurring charge to the user, instructions for displaying a delete button proximate the recurring charge, and instructions for cancelling the recurring charge if the user clicks on the delete button.

### BRIEF DESCRIPTION OF THE FIGURES

FIG. 1 shows one exemplary system for disabling recurring charges, in an embodiment.

FIG. 2 is a flowchart illustrating one exemplary method for disabling recurring charges, in an embodiment.

FIG. 3 show one exemplary sub-method of the method of FIG. 2 for identifying recurring charges, in an embodiment.

FIG. 4 shows one exemplary sub-method of the method of FIG. 2 for cancelling the recurring charge, in an embodiment.

FIG. 5 shows one exemplary system for suggesting alternate vendors of identified recurring charges, in an embodiment.

FIG. 6 is a flowchart illustrating one exemplary method for displaying a list of alternative vendors that supply a similar service to the one identified by a recurring charge, in an embodiment.

FIG. 7 shows one exemplary screen shot from the web browser of FIG. 1 illustrating display of the cancel button proximate the recurring charge, in an embodiment.

### DETAILED DESCRIPTION OF THE EMBODIMENTS

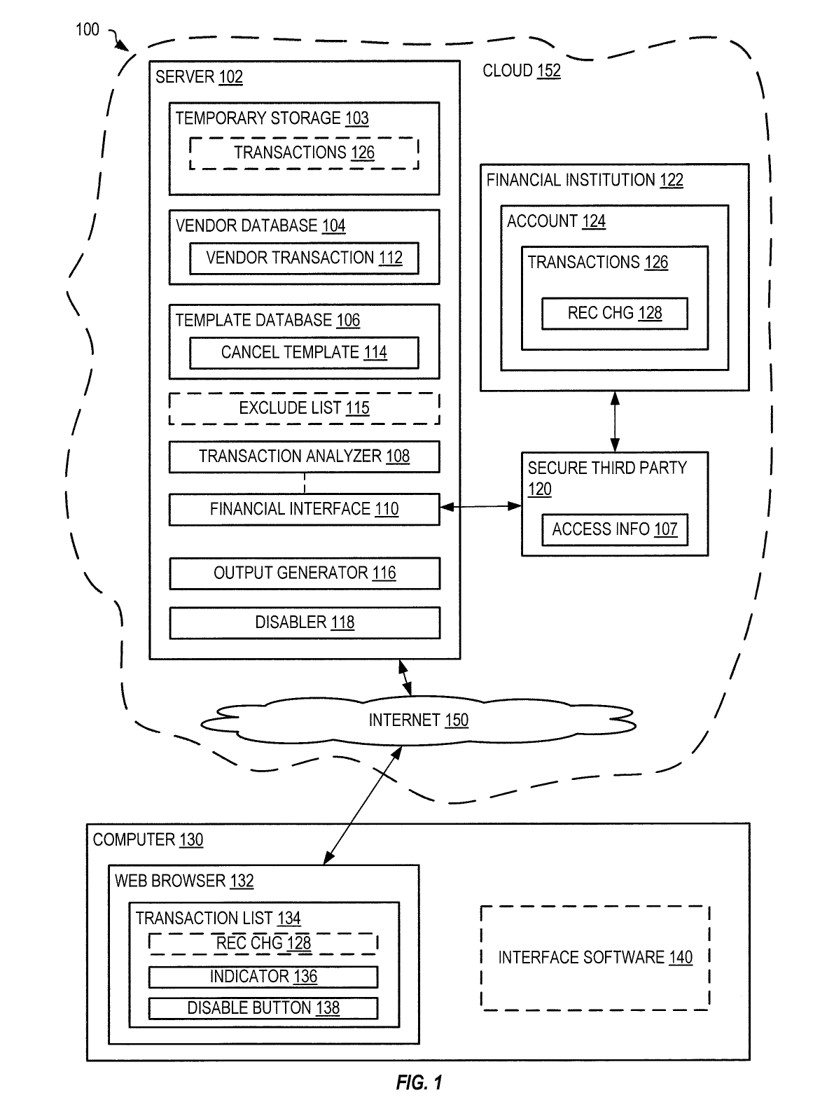

FIG. 1 shows one exemplary system 100 for disabling recurring charges. System 100 includes a server 102 that interacts, via the Internet 150, with a web browser 132 running on a computer 130 of the user. The user for example interacts with server 102, via Internet 150, to request analysis of recurring charges.

A transaction analyzer 108 of server 102 uses a financial interface 110 to interact with a secure third party 120. Transaction analyzer 108 configures web browser 132 to allow the user to provide account access information 107 for accessing information of an account 124 held by a financial institution 122 (e.g., a bank or credit company) directly to secure third party 120. Account accessing information is not stored within server 102, for example. Secure third party 120 utilized access information 107 to access transactions 126 for account 124 within financial institution 122, and under control of transaction analyzer 108, sends transactions 126 occurring within a predefined period (e.g., the last two months) to server 102 where they are stored temporarily within temporary storage 103. Secure third party 120 may for example provide a secure application programmer interface (API) framework that allows server 102 to access information within financial institution 122 once authorized by the user entering access information 107. One example of secure third party 120 is Yodlee Inc.

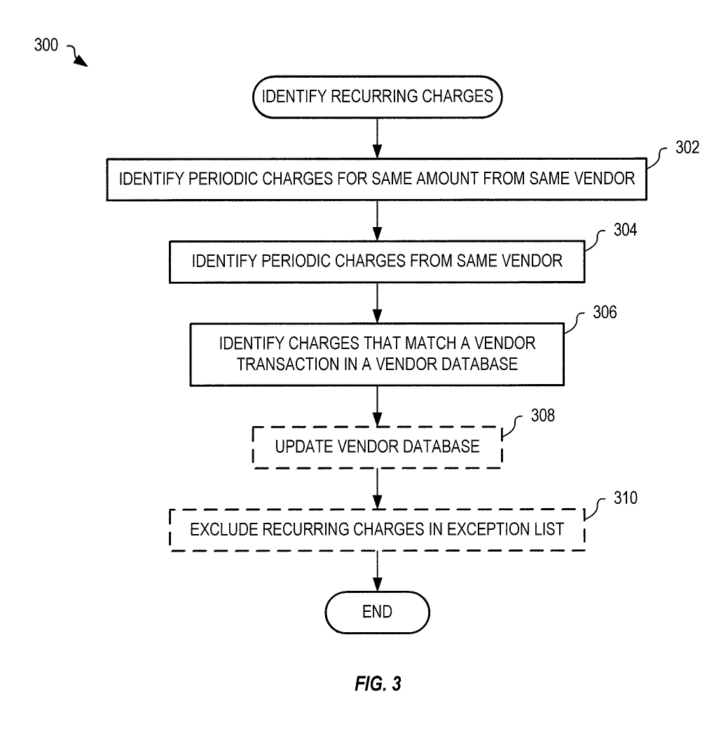

At least part of transactions 126 is retrieved from financial institution 122 and stored within temporary storage 103. Transaction analyzer 108 then utilizes an algorithm to process transactions 126 to identify a recurring charge 128. See for example process 300 of FIG. 3, where repeating transactions are identified within transactions 126. Transaction analyzer 108 may also match transactions 126 to vendor transactions 112 within a vendor database 104, where each vendor transactions 112 is a transaction of a particular vendor that is known to be recurring, for example as a result of a service and/or subscription, and that requires the user to take action to cancel it. In one embodiment, vendor transaction 112 defines a vendor ID string, a transaction ID string, and an amount that typically appears as an account transaction resulting from a recurring charge for a particular service or subscription of the vendor. Transaction analyzer 108 may for example compare each string, or a part of each string, of vendor transaction 112 to each transaction within transactions 126, where a match is assumed to identify a recurring transaction.

Optionally, server 102 may include an exclude list 115 that identifies recurring charges of vendors and service providers that should not be inadvertently cancelled, such as recurring charges for services such as power, utility, telephone, cell phone, and so on. In one embodiment, recurring charges matching entries within exclude list 115 may be identified to the user, wherein transaction analyzer 108 requests additional confirmation if the user attempts to cancel those charges.

Transaction analyzer 108 then invokes output generator 116 to indicate identified recurring charge 128 to the user, wherein output generator 116 sends a transaction list 134 to web browser 132 for display to the user. In one embodiment, transaction list 134 includes transactions 126 received from financial institution 122 and an indicator 136 that is located proximate recurring charge 128 within the list. Output generator 116 also includes a disable button 138 proximate recurring charge 128 within transaction list 134.

If the user clicks on disable button 138, a disabler 118 is invoked to disable further recurring charges from the vendor associated with recurring charge 128. Disabler 118 determines a vendor associated with recurring charge 128 and looks up a cancel template 114 within a template database 106 of server 102. Cancel template 114 defines information and actions needed to cancel the service and/or subscription associated with recurring charge 128. For example, cancel template 114 may define that information required to cancel a service as: customer first name, customer last name, and email address, and define actions required to cancel the service as: visit a web site and submit a form using the defined information. Disabler 118, based upon cancel template 114, requests the necessary information, if not available within server 102, from the user (e.g., using output generator 116 to interact with web browser 132), and then automatically performs the actions defined within cancel template 114.

Where no matching cancel template is found within template database 106 for an identified vendor, a request for human assistance is made by disabler 118, wherein the human assistant would generate cancel template 114 based upon the identified vendor. Once cancel template 114 is created, disabler 118 completes the cancellation of the associated service or subscription as described above. If necessary, disabler 118 may interact with the user via email or other means to obtain defined information of cancel template 114 when the user is no longer connected to server 102.

System 100 may notify, and allow cancellation of, more than one recurring charge of account 124 without departing from the scope hereof. Through use of system 100, the user is made aware of recurring charges that are occurring on account 124 and is provided with an easy way to cancel the associated service and/or subscription.

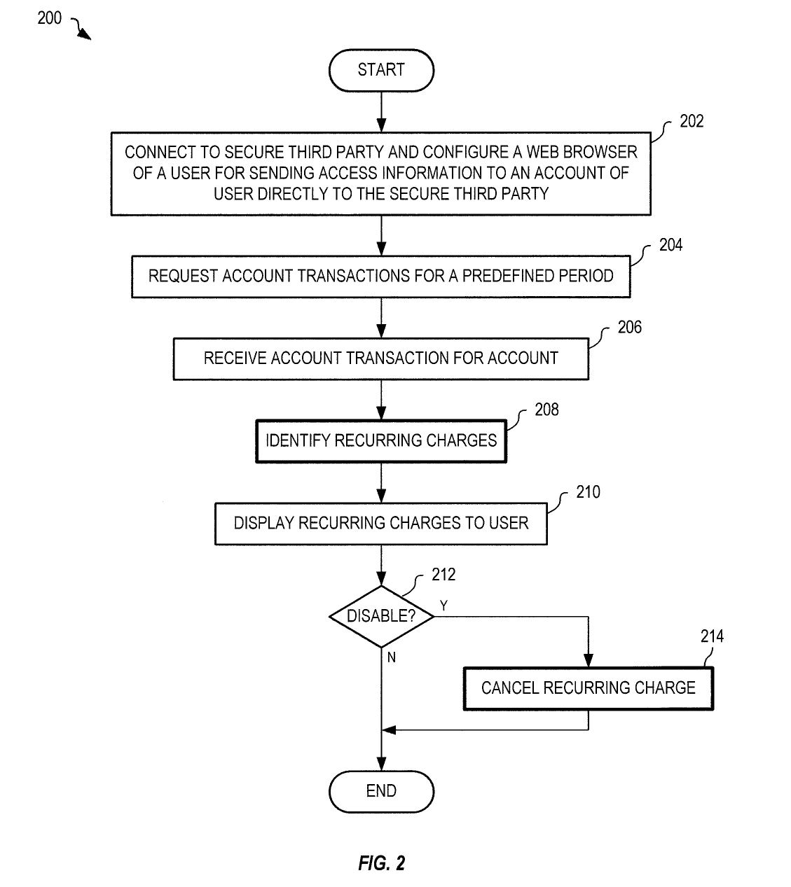

FIG. 2 is a flowchart illustrating one exemplary method 200 for disabling recurring charges. Method 200 is for example implemented within server 102 of system 100 of FIG. 1. In particular, steps 204 and 206 may be implemented within financial interface 110, steps 208 and 210 may be implemented at least in part within transaction analyzer 108, and steps 212 through 218 may be implemented, at least in part, within disabler 118.

In step 202, method 200 receives connects to a secure third party and configures a user's web browser for entering access information directly to a secure third party. In one example of step 202, the user enters access information 107, to access account 124 within financial institution 122, to secure third party 120 via web browser 132 and Internet 150. In step 204, method 200 requests account transactions of the account associated with the access information received in step 202 for a predefined period. In one example of step 204, financial interface 110 interacts with secure third party 120 to request transactions 126 of account 124 for a period of two months immediately prior to the current date from financial institution 122. In step 206, method 200 receives account transactions for the account. In one example of step 206, financial interface 110 receives at least part of transactions 126 from financial institution 122 via secure third party 120.

In step 208, method 200 invokes sub-method 300 of FIG. 3 to identify recurring charges within the transactions.

In step 210, method 200 displays identified recurring charges of step 208 to the user. In one example of step 210, transaction analyzer 108 invokes output generator 116 to display a transaction list 134 of at least part of transaction 126, including recurring charge 128 with an indicator 136 and a disable button 138, in web browser 132 for the user to view. In another example of step 210, transaction analyzer 108 invokes output generator 116 to output a dashboard of identified recurring charges (e.g., recurring charge 128) in web browser 132 together with a disable button 138 for each displayed recurring charge.

Step 212 is a decision. If, in step 212, method 200 determines that the user has clicked on disable button 138, method 200 continues with step 214; otherwise method 200 terminates. In one example of step 212, server 102 receives a click event from web browser 132 and continues with step 214 of method 200.

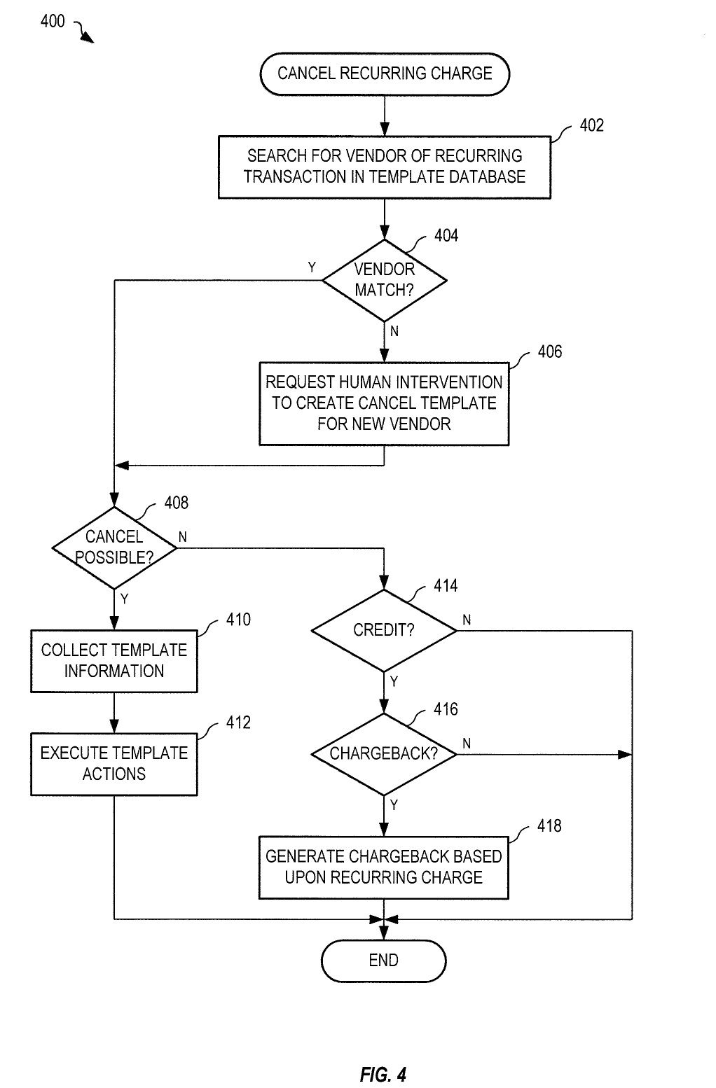

In step 214, method 200 invokes sub-method 400 of FIG. 4 to cancel the recurring charge. Steps 212 and 214 may repeat for other listed recurring charges that the user wishes to cancel. Method 200 then terminates.

FIG. 3 show one exemplary sub-method 300 for identifying recurring charges. Sub-method 300 is implemented within transaction analyzer 108, for example, and is invoked from step 208 of method 200, FIG. 2.

In step 302, sub-method 300 identifies periodic charges within the transactions that have the same associated vendor and the same monetary value. In one example of step 302, transaction analyzer 108 processes transactions 126 to identify charges that occur at a regular interval, such as weekly, monthly, biannually, annually, and so on, for the same associated vendor and for the same monetary amount. In step 304, sub-method 300 identifies periodic charges from the same vendor. In one example of step 304, transaction analyzer processes transactions 108 to identify charges from the same vendor that occur on the same day of each month, thereby identifying a recurring charge even where the monetary value differs. In another example of step 304, transaction analyzer 108 processes transactions 126 to identify charges from the same vendor that occur once or twice a year at the same time of the year, thereby identifying annually or semi-annually recurring charges.

In step 306, sub-method 300 identifies charges that match a vendor transaction in a vendor database. In one example of step 306, transaction analyzer 108 compares transactions 126 to one or more vendor transaction 112 of vendor database 104 and identifies recurring charges within transactions 126 based upon matches.

Step 308 is optional. If included, in step 308, sub-method 300 updates the vendor database based upon identified charges of step 306. In one example of step 308, transaction analyzer 108 updates vendor database 104 based upon charges identified in step 306, thereby automatically maintaining currency of vendor database 104. Step 310 is optional. If included, in step 310, sub-method 300 excludes recurring charges matched to entries within an exception list. In one example of step 310, transaction analyzer 108 excludes recurring charges that match entries within exclude list 115. In one example of step 310, transaction analyzer 108 searches exclude list 115 for a match to recurring charge 128 and excludes recurring charge 128 from identified charges, if found, to prevent accidental cancellation of payments for important services, such as power, utility, telephone, cell phone, and so on. Sub-method 300 then returns control to step 210 of method 200.

FIG. 4 shows one exemplary sub-method 400 for cancelling the recurring charge. Sub-method 400 is implemented within disabler 118, for example, and is invoked by step 214 of method 200, FIG. 2.

In step 402, sub-method 400 searches within the template database for the vendor associated with the recurring charge. In one example of step 402, disabler 118 searches template database 106 for a vendor and service/subscription match to the vendor associated with recurring charge 128. Step 404 is a decision. If, in step 404, sub-method 400 determines that a vendor match is found, sub-method 400 continues with step 408; otherwise sub-method 400 continues with step 406.

In step 406, sub-method 400 requests human intervention to create a cancel template for the vendor associated with recurring charge 128. In one example of step 406, a human creates a cancel template 114 based upon research into the identified vendor and published cancel procedures. In another example of step 406, where the human is unable to determine any cancel procedure, a cancel template for the vendor is created with an indication of “not possible”. Once a cancel template 114 has been created, sub-method 400 continues with step 408.

Step 408 is a decision. If, in step 408, sub-method 400 determines that an automatic cancel is not possible, sub-method 400 continues with step 414; otherwise sub-method 400 continues with step 410.

In step 410, sub-method 400 collects template information. In one example of step 410, disabler 118 collects information identified by cancel template 114 from the user via web browser 132 and Internet 150. In step 412, sub-method 400 executes the template actions. In one example of step 412, disabler 118 executes the actions defined within cancel template 114 using the collected template information of step 216. In another example of step 412, disabler 118 completes a form on an identified web page within cancel template 114 using the template information of step 216. Sub-method 400 then returns control to method 200.

Step 414 is a decision. If, in step 414, sub-method 400 determines that the account is a credit card account, sub-method 400 continues with step 416; otherwise sub-method 400 terminates.

Step 416 is a decision. If, in step 416, sub-method 400 determines that the user indicates that a chargeback is OK, sub-method 400 continues with step 418; otherwise sub-method 400 returns control to method 200.

In step 418, sub-method 400 generates a chargeback based upon the recurring charge. In one example of step 418, disabler 118 generates a chargeback through account 124 based upon recurring charge 128. Sub-method 400 then returns control to method 200.

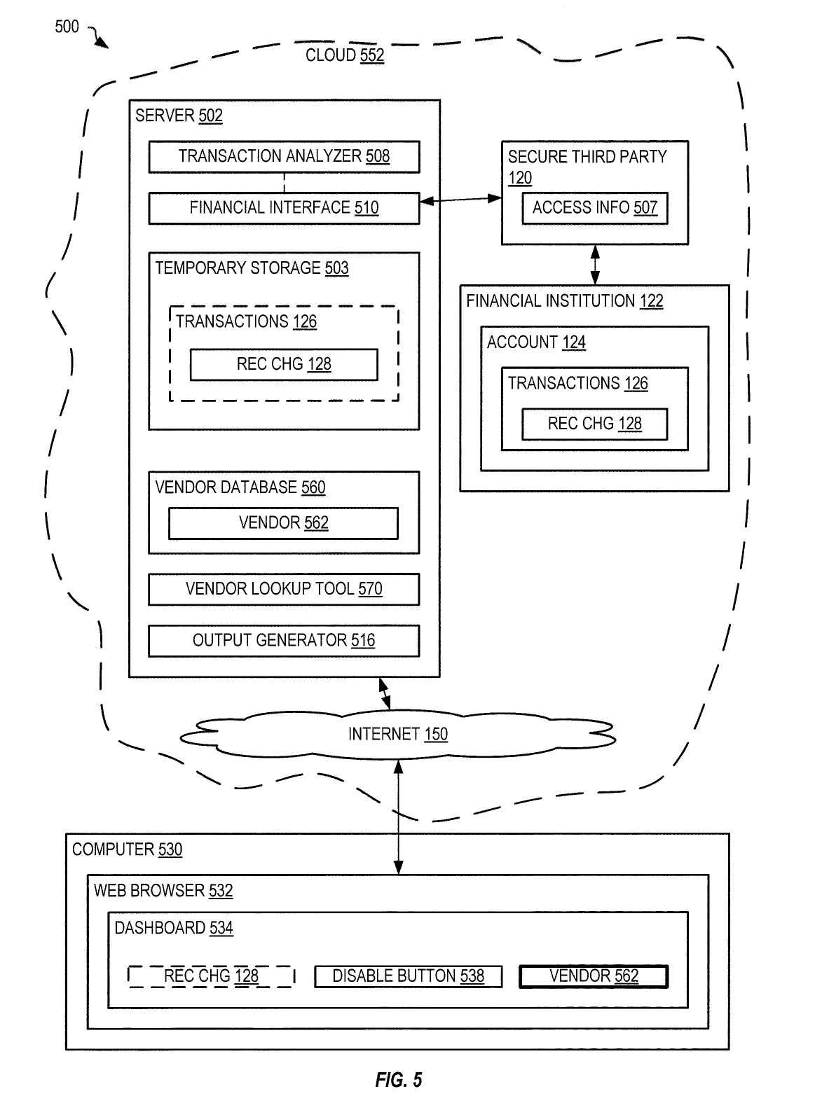

FIG. 5 shows one exemplary system 500 for identifying recurring charges and for suggesting alternate vendors to the user. System 500 has a server 502 that includes a transaction analyzer 508, a financial interface 510, temporary storage 503, and an output generator 516. System 500 is similar to system 100 of FIG. 1 where similarly named components have similar function. For example, system 500 identifies recurring charge 128 within transactions 126 of account 124 stored within financial institution 122. System 500 also includes an alternate vendor database 504 that stores vendor information 562 that is cross-referenced based upon the type of service and/or subscription provided by the vendor and a vendor lookup tool 570 that searches vendor database 560 to identify vendor 562 that provides a similar service and/or subscription to the vendor associated with recurring charge 128. Alternate vendor database 560 may include information regarding each vendor, such as popularity with other clients, cost of service, location of service, and so on, such that vendor 562 may be matched to the service and/or subscription, location, and other relevant information of the vendor associated with recurring change 128.

In one example of operation, output generator 516 displays a dashboard 534 within web browser 532 running on a computer 530 of a user. Dashboard 534 may for example display recurring charge 128, a disable button 538 that allows the user to disable recurring charge 128, and a recommended alternate vendor 562 as determined by vendor lookup tool 570. In one embodiment, vendor lookup tool 570 determines vendor 562 based upon recurring charge 128 and a lowest cost. In another embodiment, vendor lookup tool 570 determines vendor 562 based upon recurring charge 128 where the vendor has no service charge (e.g., a free service).

In another embodiment, vendor lookup tool 570 is invoked when the user clicks on disable button 538, such that one or more alternate vendors 562 are displayed, for example within a pop-up window, only when the user indicates that recurring charge 128 is to be cancelled.

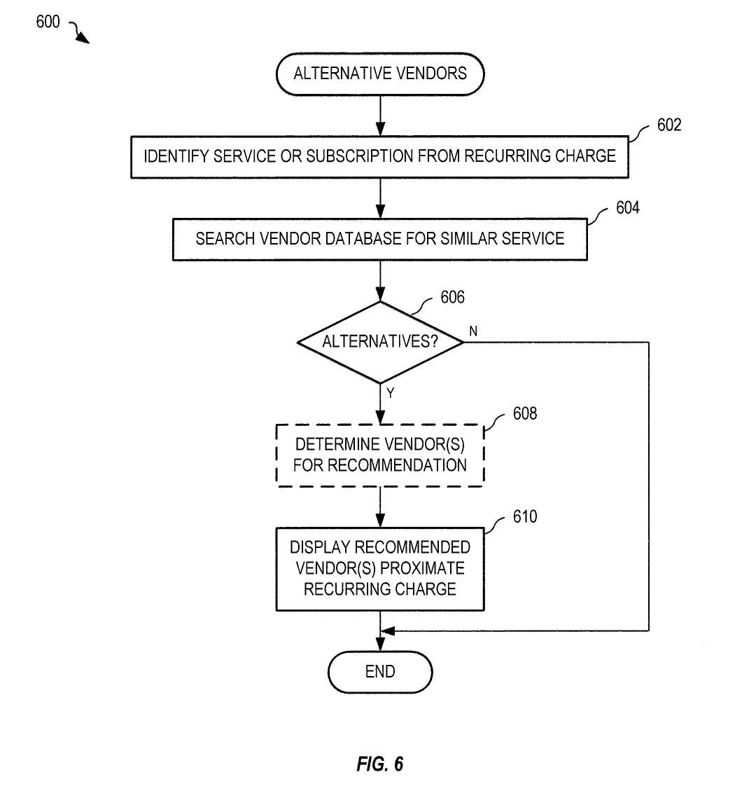

FIG. 6 is a flowchart illustrating one exemplary sub-method 600 for displaying a list of alternative vendors that supply a similar service to the one identified by the recurring charge. Sub-method 600 is for example implemented at least in part by vendor lookup tool 570 and output generator 516 of system 500, FIG. 5, and is invoked for example by transaction analyzer 508 and/or output generator 116 of system 500 when one or more recurring charges 128 are displayed to the user, and/or is invoked by disabler 118 of system 100, FIG. 1, when the user clicks on disable button 138/538.

In step 602, sub-method 600 identifies a service and/or subscription associated with a recurring charge. In one example of step 602, vendor lookup tool 570 determines a service and/or subscription of a vendor associated with recurring charge 128. In step 604, sub-method 600 searches a vendor database for a similar service. In one example of step 604, vendor lookup tool 570 searches vendor database 560 to identify vendor 562 based upon the identified service and/or subscription of step 602.

Step 606 is a decision. If, in step 606, sub-method 600 determines that alternative vendors are available, sub-method 600 continues with step 608; otherwise sub-method 600 terminates. Step 608 is optional. If included, in step 608, sub-method 600 determines one or more vendors to recommend to the used from the one or more vendors identified in step 604. In one example of step 608, vendor lookup tool 570 determines vendor(s) 562 for recommendation based upon one or both of service cost and service compatibility. For example, vendor 562 may be recommended because it offers a free service.

In step 610, sub-method 600 displays recommended vendors proximate the displayed recurring charge. In one example of step 610, vendor lookup tool 570 cooperates with output generator 516 to display vendor 562 near recurring charge 128 within web browser 532.

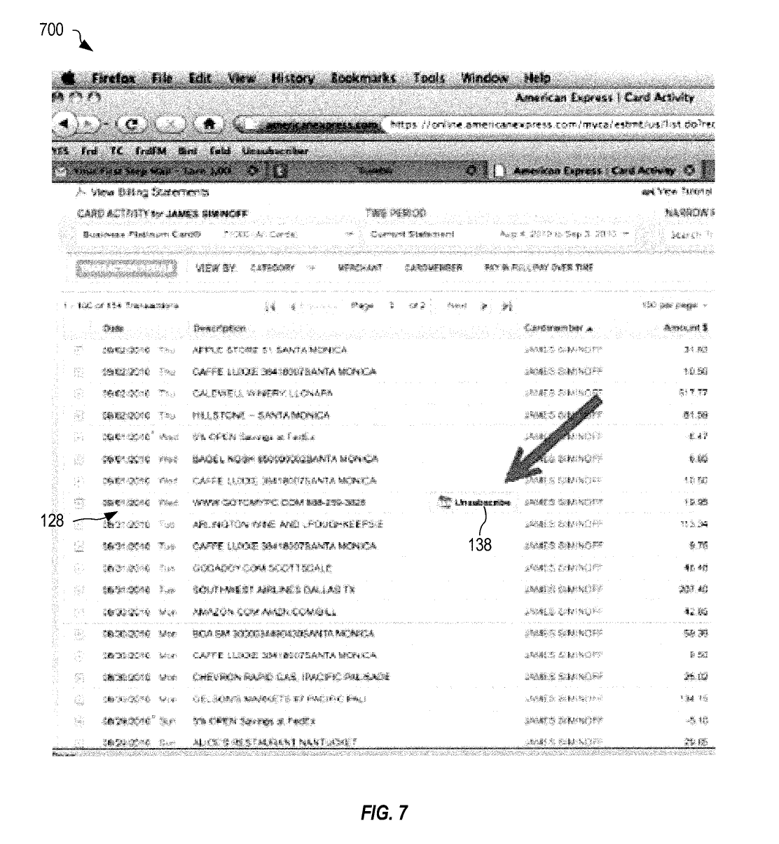

FIG. 7 shows one exemplary screen shot 700 from web browser 132 illustrating display of disable button 138 proximate recurring charge 128.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for disabling recurring charges incurred on an account of a user, comprising:
a transaction analyzer, running on a server, for identifying a recurring charge within transactions of the account; and
an output generator for indicating the identified recurring charge to the user.

2. The system of claim 1, further comprising a financial interface for interfacing with a secure third part to receive the transactions from a financial institution managing the account.

3. The system of claim 1, wherein the output generator generates a dashboard display for displaying transactions associated with the recurring charge.

4. The system of claim 3, the dashboard display displaying only transactions associated with the recurring charge.

5. The system of claim 1, further comprising a vendor database for storing vendor transactions of known recurring charges, wherein the charge analyzer further identifies recurring charges within the transactions that match any one of the vendor transactions.

6. The system of claim 1, further comprising:
a template database for storing a cancel template that defines information required and actions to disable the recurring charge for a vendor associated with the recurring charge; and
a disabler for cancelling the identified recurring charge using the cancel template.

7. The system of claim 1, further comprising an exclude list for matching to recurring charges that should not be inadvertently cancelled.

8. A method for disabling recurring charges incurred on an account of a user, comprising the steps of:
receiving, within a server, a plurality of transactions that occurred within a predefined period for the account;
analyzing the transactions to identify a recurring charge;
indicating the identified recurring charge to the user;
displaying a delete button proximate the recurring charge; and
cancelling the recurring charge if the user clicks on the delete button.

9. The method of claim 8, the step of receiving comprising interacting with a secure third party to receive the plurality of transactions.

10. The method of claim 8, wherein the list of transactions is displayed to the user within a web browser.

11. The method of claim 8, further comprising identifying recurring charges that should not be inadvertently cancelled.

12. A software product comprising instructions, stored on non-transient computer-readable media, wherein the instructions, when executed by a computer, perform steps for disabling recurring charges incurred on an account of a user, comprising:
instructions for receiving, within a server, a plurality of transactions that occurred within a predefined period for the account;
instructions for analyzing the transactions to identify a recurring charge;
instructions for indicating the identified recurring charge to the user;
instructions for displaying a delete button proximate the recurring charge; and
instructions for cancelling the recurring charge if the user clicks on the delete button.

13. The software product of claim 12, the instructions for receiving comprising instructions for interacting with a secure third party to receive the plurality of transactions.

14. The software product of claim 12, wherein the list of transactions is displayed to the user within a web browser.

15. The software product of claim 12, further comprising instructions for identifying recurring charges that should not be inadvertently cancelled.
